(19) United States
(12) Patent Application Publication
(10) Pub. No.: US 2015/0104768 A1
(43) Pub. Date: Apr. 16, 2015

(54) TRAINABLE SKILL PRACTICE PLANNING AND REPORTING SYSTEM

(71) Applicant: ModernStat LLC, Nashville, TN (US)

(72) Inventor: Christopher M. Clark, Brentwood, TN (US)

(73) Assignee: MODERNSTAT LLC, Nashville, TN (US)

(21) Appl. No.: 14/508,619

(22) Filed: Oct. 7, 2014

Related U.S. Application Data
(60) Provisional application No. 61/889,344, filed on Oct. 10, 2013.

(51) Int. Cl. G09B 19/00; G09B 5/00

(52) U.S. Cl. CPC G09B 19/0038; G09B 5/00
USPC 434/219; 434/322; 434/362; 434/247

(57) ABSTRACT

A trainable skill practice planning and reporting system generates a practice plan to use in training a student to improve in the performance of trainable skills associated with an activity, such as an athletic activity. The system tracks the student's performance statistics, uses those statistics to determine trainable skills, and compares the student's performance of those skills to target values. The target values may be determined by past performance, goals, peers or benchmarks. Through comparison of actual performance to target values, the system determines the skills having the largest separation between current skill level and target skill value. The system then selects practice drills from a library of drills to most effectively train the student to improve performance of the skills that are most lacking.

### RELATED APPLICATIONS

This application claims priority to provisional patent application Ser. No. 61/889,344, filed Oct. 10, 2013, titled “Auto Drill Practice Planning System to Track Athletic Performance and Improvement.”

### FIELD

This invention relates to providing training to improve a student's performance of a trainable skill. More particularly, this invention relates to a system for planning practice routines for students and tracking improvement in student performance as practice routines are completed.

### BACKGROUND

Details of deficiencies in an athlete's “game” are usually lost in the fog of athletic competitions. This makes it difficult for an athlete to objectively evaluate his or her performance and accurately focus available practice time on skills that if improved would provide the largest return in competition results for the practice time invested.

Prior practice planning systems have not provided for an objective evaluation of the athlete's initial skills prior to putting together a practice plan. Prior systems also have required too much user effort in configuring the systems before the athlete can actually start practicing. Further, prior systems have required constant ongoing reconfiguration of practice plans.

What is needed, therefore, is a practice planning system that determines an athlete's initial and current skill levels based on statistical analysis of competitive performance data as well as ongoing analysis of the results of practice drills, including successful completion of the drills and success in attaining certain goals set for the drills.

### SUMMARY

Described herein is a system that tracks an athlete's competitive performance statistics, uses those statistics to determine trainable skills, and compares the athlete's performance of those skills to target values. The target values may be determined by one or more of past performance, goals, peers or benchmarks. Through comparison of actual performance to target values, the system determines the skills having the largest separation between current skill level and target skill value. The system then selects practice drills from a library of drills to most effectively train the athlete to improve performance of the skills that are most lacking.

In prior practice planning systems, the athlete or coach had to tell the system the initial skill level of the athlete. This introduces subjective bias into the process. Unlike the prior systems, embodiments of the system described herein use competitive performance statistics to determine initial skill levels and practice drill results to determine ongoing drill completion result goals. This takes the subjectiveness of the athlete, coach, or trainer out of the equation, thereby allowing pure statistics and objective practice performance results to determine the path to improvement.

As the term is used herein, a “trainable skill” is any skill used in athletics, music, academics, the workplace, or any other activity or field of endeavor that may be improved with training and practice.

A preferred embodiment of the invention provides a method for generating a practice plan to use in training a student to improve in the performance of trainable skills associated with an activity. The method includes the following steps:
(a) storing a plurality of trainable skills in a database that is accessible via a communication network;
(b) storing a plurality of drills in the database, each drill associated in the database with one or more of the trainable skills;
(c) selecting one or more of the trainable skills in which improved student performance is desired, the selecting performed using one or both of an instructor computer and a student computer connected to the communication network;
(d) assigning goal values for the trainable skills selected in step (c), the assigning performed using one or both of the instructor computer and the student computer;
(e) after the student participates in the activity during which the student performs one or more of the trainable skills, entering performance data in the database using the student computer, the performance data indicative of a level of skill exhibited by the student in performing the one or more trainable skills;
(f) determining baseline values for the one or more trainable skills selected in step (c) based on the performance data recorded in step (e), the determining performed by a computer processor in communication with the database;
(g) the computer processor generating the practice plan for the student by:
   (g1) determining a deviation between the goal value and the baseline value for each trainable skill selected in step (c);
   (g2) allocating a practice time for each trainable skill based at least in part on the deviations determined in step (g1), wherein trainable skills having the largest deviations are allocated more practice time than trainable skills having the smallest deviations;
   (g3) selecting drills from the database that are associated with trainable skills having deviations greater than a minimum threshold value;
   (g4) setting completion goals for the drills selected in step (g3) that are scored drills; and
   (g5) compiling at least the drills, practice times, and completion goals as the practice plan; and
(h) making the practice plan accessible to one or both of the instructor computer and the student computer via the communication network.

In some embodiments, step (g2) of the method further comprises:
based on the deviations determined in step (g1), grouping the trainable skills selected in step (c) into at least three skill packs, wherein one or more trainable skills having the largest deviations are grouped into a first skill pack, one or more trainable skills having deviations smaller than those in the first skill pack are grouped into a second skill pack, and one or more trainable skills having deviations smaller than those in the second skill pack are grouped into a third skill pack; and
allocating more practice time for the first skill pack than for the second skill pack or the third skill pack.

In some embodiments, the method includes one or more of the following steps performed prior to step (g) using the instructor computer:
entering a parameter value that indicates a scope of the practice plan, the parameter value comprising one or more of an estimated time duration of the practice or a predetermined number of drills to be performed during the practice;
selecting particular drills from the database to include in the practice plan;
selecting whether to push the student in one or more of the selected drills; and
selecting completion goals for scored drills in which the student has no performance history.

In some embodiments, the method includes the following steps:

in step (h), the practice plan is made accessible to the instructor computer only;
(i) an instructor viewing the practice plan on the instructor computer;
(j) the instructor entering revisions to the practice plan using the instructor computer; and
(k) making the practice plan accessible to the student computer after step (j).

In some embodiments, the method includes the following steps:
(i) the student viewing the practice plan on the student computer;
(j) the student selecting a drill from the practice plan to view using the student computer;
(k) the student completing the drill selected in step (j);
(l) the student entering results of the drill completed in step (k) into the database using the student computer;
(m) storing the results entered in step (l) in the database;
(n) repeating steps (i) through (m) until all drills in the practice plan have been completed;
(o) accessing the practice plan and the results of the drills from the database using the instructor computer;
(p) an instructor viewing the practice plan and the results of the drills on the instructor computer;
(q) the instructor entering revisions to the practice plan based on the results of the drills using the instructor computer; and
(r) making a revised practice plan accessible to the student computer after step (q).

In sonic embodiments, the method includes repeating steps (e) through (r) until one or more of the deviations determined in step (g1) are less than the minimum threshold value.

In another aspect, the invention provides an apparatus for generating a practice plan to use in training a student to improve in the performance of trainable skills associated with an activity. In a preferred embodiment, the apparatus includes a student computer, an instructor computer, a database and an application server computer, all of which are in communication with each other via a communication network, such as the Internet.

The student computer is operable to enter student account information, performance data, and results of drills, and to display the practice plan. The instructor computer is operable to enter instructor account information, selections of the trainable skills in which improved student performance is desired, and goal values for selected trainable skills.

The database is operable to store (1) student account information in association with instructor account information, (2) drills in association with the selected trainable skills, (3) goal values in association with the selected trainable skills and the student account information, (4) baseline performance values in association with the selected trainable skills and the student account information, (5) performance data in association with the selected trainable skills and the student account information, where the performance data is indicative of a level of skill exhibited by the student in performing the one or more selected trainable skills, (6) practice plans in association with the student account information and/or the instructor account information, (7) and results of drills performed by the student in association with the student account information.

In preferred embodiments of the apparatus, the application server computer is programmed with executable instructions to:
access the selected trainable skills in which improved student performance is desired;
access the goal values for the selected trainable skills;
access the performance data indicative of the level of skill exhibited by the student in performing the selected trainable skills;
calculate the baseline performance values for the selected trainable skills based on the performance data;
determine deviations between the goal values and the baseline performance values for the selected trainable skills;
allocate practice times for the selected trainable skills based at least in part on the deviations, wherein selected trainable skills having the largest deviations are allocated more practice time than selected trainable skills having the smallest deviations;
select drills from the database associated with the selected trainable skills having deviations greater than a minimum threshold value;
set completion goals for selected drills that are scored drills;
compile at least the selected drills, the practice times, and the completion goals as the practice plan;
store the practice plan in the database in association with the student account information and/or the instructor account information; and
make the practice plan accessible to the instructor computer and/or the student computer via the communication network.

In some embodiments, the apparatus includes a web server computer connected to the communication network. The web server computer is programmed with executable instructions to transfer practice-related information to and from the student computer, the instructor computer, and the application server computer via the communication network, and to access and store practice-related information in the database. The student computer of these embodiments executes a student web browser application for communicating with the web server computer, and the instructor computer executes an instructor web browser application for communicating with the web server computer.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a functional block diagram of an athletic skill practice planning and reporting system according to a preferred embodiment;

FIGS. 2-4 depict flow charts of an athletic skill practice planning and reporting system according to a preferred embodiment;

FIG. 5 depicts an exemplary listing of trainable golf skills and coaches for such skills;

FIG. 6 depicts an exemplary listing of trainable baseball skills and instructors for such skills; and

FIGS. 7A and 7B depict correlations between trainable skill improvement and drill performance.

### DETAILED DESCRIPTION

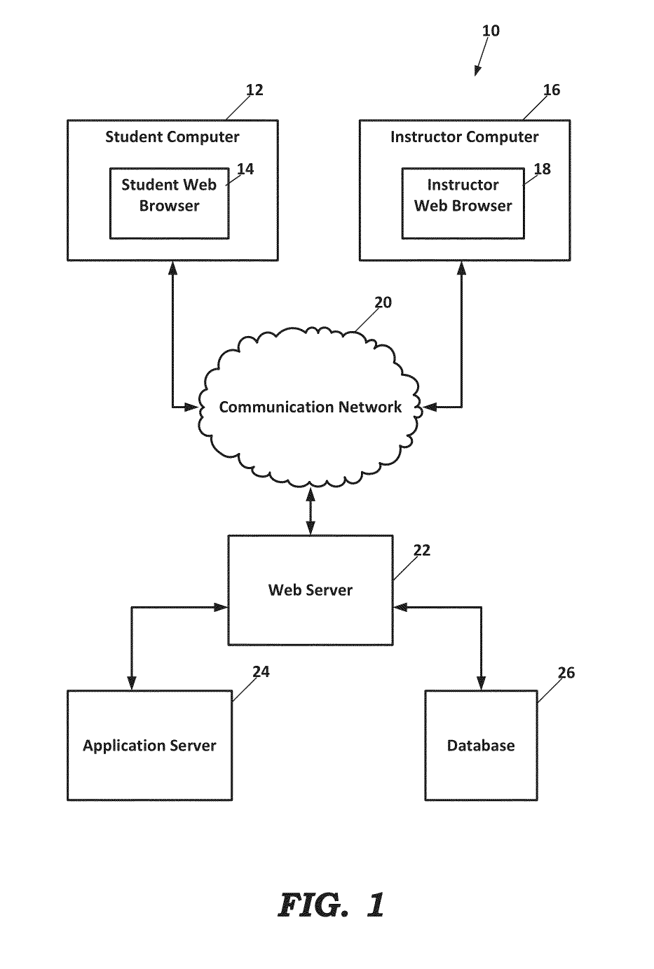

As shown in FIG. 1, a preferred embodiment of an athletic skill practice planning and reporting system 10 includes a student computer 12 running a web browser 14, an instructor computer 16 running a web browser 18, a wide area communication network 20, a web server 22, an application server 24, and a database 26. The student computer 12 and the instructor computer 16 may be desktop personal computers, laptop computers, tablet computers, smart phones, or other computing devices that are capable of communicating over the network 20. In some embodiments, instead of using web browsers, the student computer 12 and the instructor computer 16 communicate with the application server 24 using web-enabled applications, generally referred to as “apps”. The wide area communication network 20, which in the preferred embodiment is the Internet, comprises wired and wireless communication nodes that are interconnected to provide communication between nodes.

The web server 22 is preferably a server computer connected to the communication network 20 that sends and receives practice-related information to and from the student computer 12 and the instructor computer 16 via the communication network 20 and accesses and stores such information in the database 26. This practice-related information could be statistical data used to populated the database 26 for target/baseline calculations, skill information regarding new skill-targeted drills for entry into a library of drills, or information indicating results of the student's performance of drills during a practice.

The application server 24 is preferably a server computer in communication with the web server 22 that handles calculations using the data that are input into the database 26. The application server 24 also determines which calculations to run and which data to deliver to the student computer 12 and the instructor computer 16 via the communication network 20. Determination of the data to deliver may be based on the type of data request received, such as for statistics, baseline information, drills, or practice results.

The database 26 stores trainable skills, drills used in training those trainable skills, and practice plans incorporating the drills. Student account information and instructor account information is also stored in the database 26. Results from competitions involving the trainable skills, practice results, and target values are also stored in the database 26.

A practice plan creation event is triggered either by the student, an instructor, or a scheduling function. The application server 24 processes the student's trainable skill statistical values and compares them with the target values to determine a weighted order of deficiency. An allotted time for each practice is set, and the application server 24 accesses the drill library and sorts by trainable skill to create a practice plan for the student and store it in the database 26. Each drill has a result goal that gives the student a target, also referred to herein as a “completion result goal,” to strive for when completing that drill. If there are no previous results for the particular drill for the particular student in the database 26, a default value is used. If there are previous results, the application server 24 uses logic to determine what the goal should be for the particular practice in order to continue to push the student to improve. Depending on the configuration of the system, the practice plan may be immediately available to the student computer 12 via the web server 22, placed on a schedule in the database 26 to be accessible at a future date/time, or it may await approval by an instructor before it is accessible to the student.

To access the practice plan via the student computer 12, the student uses the web browser 14 to contact the web server 22, which pulls the practice plan from the database 26. The student can then see the practice plan, which consists of a list of drills, on the display of the student computer 12. The student may then click on/access each drill which causes the student computer 12 to display information about the selected drill. This information may include what equipment is needed to complete the drill, a “how to” explanation of the drill, previous results (if any) of completing the drill, and a completion result goal for the drill. The student then physically performs the drill, inputs the results into the student computer, and submits the results to the web server 22 which stores the practice result data in the database 26. Upon creation of the next practice, the application server 24 takes prior practice result data into account when determining the completion result goal for the drills. The student can also use the student computer 12 and browser 14 to enter new statistical values for each trainable skill, such as data from competitions, which the application server 24 may use to continue to adjust practice plans based on the weighted skill deficiencies of the student.

Once a drill library is populated in the database 26 and the drill library is linked to certain trainable skills, and the student's statistics and skill targets are entered, the application server 24 uses mathematics and logic to build a practice plan based on established parameters, such as length of time, available resources, and subsection of drills. The application server 24 compares the student's competition statistical data for the defined skills and to the target values for those skills. The application server 24 orders the skills from most deficient to least deficient, and weights the levels of deficiencies. The application server 24 accesses the subset of available drills, which may be filtered by user preference, effectiveness rating, availability of resources to complete the drills, or just frequency of use. Based on the order and weight of skills deficiency, the application server 24 creates a practice plan for the student having a time duration that is as close to the allotted time as possible.

Each drill in the practice plan has an estimated time to completion and a completion result goal, which is the result the student is trying to achieve or exceed in the particular drill. For example, if the drill is to hit fifteen putts from five feet, the completion result goal may be to make ten of the fifteen putts. The drill might be setup in the drill library so that the initial completion result goal is ten made putts, but after the student has completed the drill and entered those results into the system, the next time a practice plan is created that uses this drill, the completion result goal may be determined by that student's prior performance of that drill.

In preferred embodiments, when the student accesses the practice plan via the webserver 22, logic validates the format of practice results that the student inputs. For example, the input results must be a number or a value within a set range. As the student inputs the results data and it is stored in the database 26, the application server 24 will consider this data and each drill's completion result goal as it calculates the student's deficiencies for use in building the next practice,

As an example, an embodiment of the system 10 is used to set up a practice for two trainable golf skills: “accuracy off the tee” and “1 putting.” Drills are entered for “accuracy off the tee” and “1 putting” along with time to complete and an initial completion result goal. A golfer plays a round of golf and records values indicating success at hitting the fairway (accuracy off the tee) and success in “1 putting.” The golfer uses the student computer 12 to connect to the webserver 22 via the Internet 20, create an account, input the values from that round and the golfer's goals for “accuracy off the tee” and “1 putting,” request a practice plan, and define a time limit for the practice.

The application server 24 creates a weighted skill deficiency order for the two skills based on the inputted values and goals, accesses the available drills from the database 26, adds a selection of drills to the practice plan that is weighted toward the most deficient of the two skills, and determines the time duration of each drill to stay within the desired total time duration of the practice. The individual drill completion result goals are set as the defaults. The practice plan is then returned via the Internet 20 to the student computer 12.

The golfer goes out on the golf course or practice area and completes the drills defined in the practice plan and inputs the performance results for each drill using the web browser 14 on the student computer 12. The performance results data are stored in the database 26. The golfer later plays two more rounds of golf and, using the student computer 12, enters the statistics from those two rounds into the system 10 and requests another practice plan.

The application server 24 then calculates a weighted skill deficiency order using the statistics from all three rounds, giving greater weight to the data from the most recent two rounds. The application server 24 accesses the drill library in the database 26 and creates a practice plan within the defined time limit. Because the golfer has previously completed some practice drills, if those same drills are selected again for the next practice, the application server 24 accesses those previous results and sets the drill completion result goal at one level of difficulty higher for the next practice. For example, with the “fifteen putts at five feet” drill, if the golfer's average result is eight makes, one level of difficulty higher would be nine makes. In a preferred embodiment, the decision to increase the difficulty of the drill is a random logic decision. In alternative embodiments, a preference could be set at the time of requesting creation of a practice plan to “push all drill completion result goals one step harder today.” Upon completion of the practice plan by the application server 24, the plan is returned to the golfer's computer 12 via the network 20. This process may continue infinitely, with the golfer adding more rounds and more practice results and the system 10 continually tweaking the practice plans to help the golfer practice in those areas that need the most help.

In some embodiments, the golfer may have an instructor who has set up pre-defined aspects within the system 10, such as a subset of drills to use, custom-created drills, and emphasis on certain trainable skills. In these embodiments, the practice plan may be generated based on events triggered by the instructor, and then the instructor reviews the practice plan before the golfer has access to it. To review and edit the practice plan, the instructor logs into instructor's account on the system 10 using the web browser 18 on the instructor computer 16. During the review process, the instructor may remove drills, de-emphasize skills or drills, customize drill completion result goals, and change other variables involved in the practice generation process. The revisions may be made as one-time adjustments, in which case the instructor just changes the values for one drill or practice. Alternatively, the revisions could be set as preferences, in which case the system either changes the weighted value for a skill or drill for the particular golfer or removes a drill altogether for the practice plan for that golfer.

In some embodiments, each instructor may have a custom subset of drills and preferences for drills and trainable skills linked to their account in the database 26. These preferences may be set up by the instructor after the instructor has logged into their account on the system 10 using the web browser 18. Students who are linked to the instructor in the database 26 can use the instructor's preferences and drill library when requesting creation of a practice plan. In some embodiments, a student may be able to receive more than one practice plan, such as one plan generated based on the student's preference setup and another plan based on the instructor's preference setup.

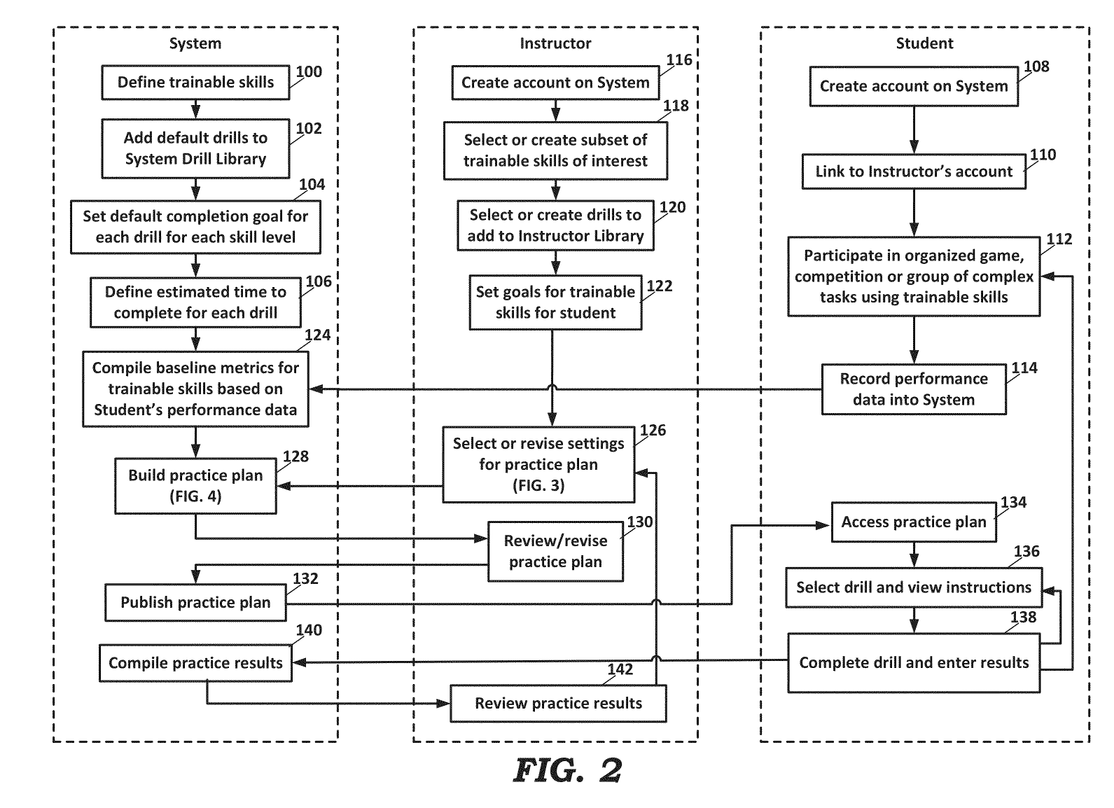

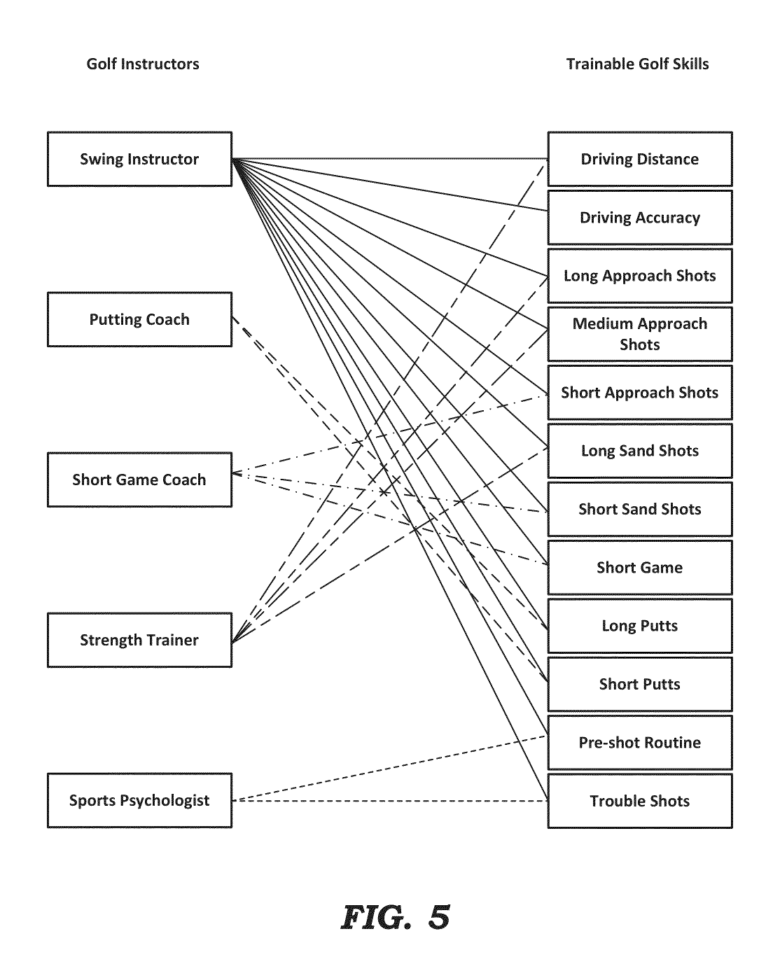

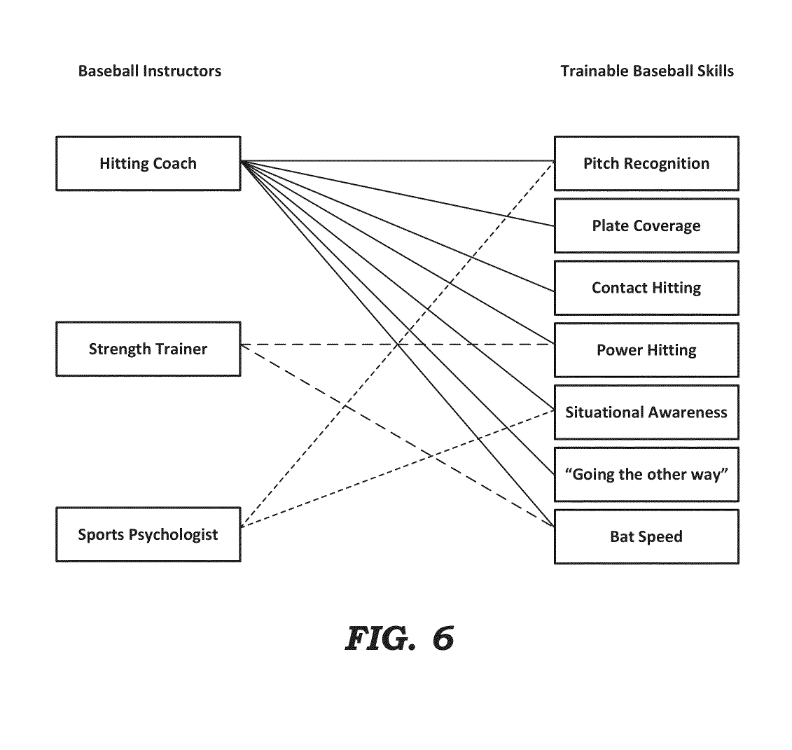

An exemplary process flow for the setup and use of a preferred embodiment of the invention is shown in FIGS. 2, 3 and 4. With reference to FIG. 2, a set of trainable skills are defined in the database 26 of the system 10 (step 100), such as the trainable golf skills listed in FIG. 5 or the trainable baseball skills listed in FIG. 6. Default practice drills are added to the drill library in the database 26 (step 102). Each practice drill is designed to train at least one trainable skill, although some drills may train multiple skills. Preferably, each drill stored in the database 26 includes definition data that defines the task and how to complete it, such as an instructional video.

A drill may be one of two types: a pass/fail drill or a scored drill. A pass/fail drill is a task that must be completed. For example, “Take five swings in the mirror” is a pass/fail drill. A scored drill is a drill having a success goat that the student tries to achieve when doing the drill, and the student's progress is tracked. For example, “Throw ten pitches and count how many strikes you throw” and “play nine holes from the red tees and count strokes” are scored drills. In some embodiments, scored drills can be broken down into score drills and repetition drills. For example, a repetition drill may be “Throw ten pitches and count how many strikes you throw,” where the ten pitches could be changed to 15 pitches, 20 pitches, etc.

Default completion goals are set for each drill (step 104). If the drill is a scored drill, then a completion goat is set. The default value for a completion goal is whatever the goal is set to without any additional parameters. For example, the default completion goal for a pitching scored drill might be to throw eight strikes out of ten pitches, or for a golf scored drill to hit thirty-three strokes for nine holes from the red tees. In some embodiments, skill level completion goal presets are an option, such as a “Pro lever” goal of nine strikes out of ten pitches or a “Rookie level” goal of five strikes out of ten pitches. For the initial practice setup, an initial preset level goal would be defined. With either the default setup or the presets, an estimated time to complete the drill is also defined (step 106).

With continued reference to FIG. 2, a student creates an account to join the system, either based on his/her on own initiative or through an invitation from an instructor who already has an account (step 108). In a preferred embodiment, the student account is linked to an instructor's account in the database 26 so that the instructor can administer practices for the student (step 110). The student then participates in an organized game or competition, or performs a group of complex tasks that consist of the trainable skills in the system (step 112). For example, the student may play a baseball game, play a round of golf, throw pitches in a bullpen, or go through some other organized process utilizing trainable skills. During or after the game/competition/activity, the student records performance data and enters the data into the system using the web browser 14 (step 114). For example, the performance data may include the number of fairways hit, the number of puts made, the number of balls and strikes thrown, the number of pitches hit, and the numbers of swings and misses.

As shown in FIG. 2, an instructor also creates an account to join the system (step 116). After creating the account, the instructor has the opportunity to select a subset of trainable skills in which the instructor specializes (step 118). These are added to the Instructor Library in the database 26. For example, a putting instructor may only be interested in the putting skills in golf. The instructor may also create a customized subset of trainable skills in which the instructor has defined baseline values for his/her students. Alternatively, the instructor may allow the students to enter the baseline values themselves. The instructor selects predefined drills from the database 26 to add to his/her drill library, or the instructor may create his/her own drills to include in the drill library (step 120). The instructor also sets goals for trainable skills for his/her students (step 122). These goals are set as values the student is striving to achieve in their “competitive metrics.” These goals can be set arbitrarily by either the student or instructor, or be set based on some role model the student is striving to emulate.

Based on the student's performance data entered at step 114, the system compiles baseline statistical metrics for the trainable skills (step 124). For the examples of golf, baseball hitting, and baseball pitching, these trainable skills and metrics may be as listed in Tables 1, 2 and 3, respectively.

TABLE 1
Golf Trainable Skills and Metrics.

| Trainable Skill | Metric |
|---|---|
| Driving Accuracy | Fairway hit percentage |
| Approach Accuracy | Percentage of time hitting the green from fairway |
| Short Game | Scrambling percentage or up and down percentage |
| Bunker Play | Sand save percentage |
| Long Putting | Strokes gained putting; percentage of two & |
| | three putts |
| Short Putting | Percentage of putts made inside ten feet |

TABLE 2
Baseball Hitting Trainable Skills and Metrics.

| Trainable Skill | Metric |
|---|---|
| Contact | Swing and miss percentage |
| Hitting for Power | Slugging percentage |
| Plate Coverage | Swing and miss by plate sections |
| Situational Awareness | Batting average and slugging percentage based on |
| | count |
| Pitch Awareness | Swing and miss compared to pitch type |

TABLE 3
Baseball Pitching Trainable Skills and Metrics.

| Trainable Skill | Metric |
|---|---|
| Fastball Location | Hitting spot percentage with fastball |
| Off-Speed Location | Hitting spot percentage with off-speed pitches |
| Situation Awareness | Batting average against based on count |
| Consistency | Hitting spot percentage difference from inning to |
| | inning |
| Competiveness | Percentage of strikes thrown based on counts |

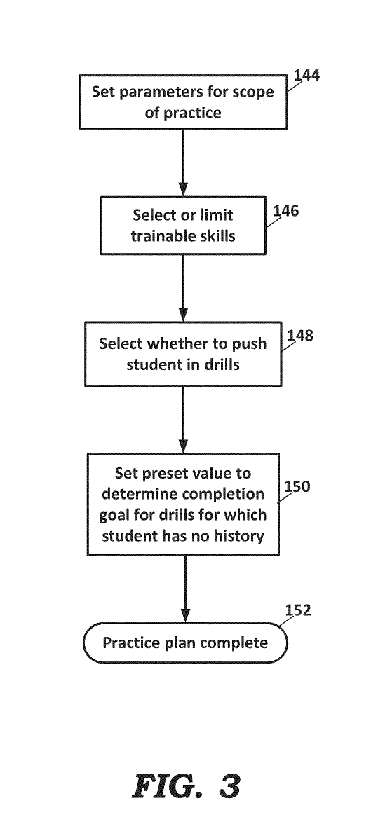

Based on the goals set for trainable skills for a particular student (step 122), the instructor selects settings for generating a practice plan for the student (step 126). Alternatively, the student can trigger a practice plan build without the involvement of a coach. The selections made by the instructor are depicted in FIG. 3. First, the instructor selects a parameter to determine the size and scope of the practice (step 144). This parameter may be in the form of an estimated time duration of practice or a defined number of drills. The instructor may also select or limit the skills that are trained in this practice (step 146). This is done either by selecting skills from a list or, when the instructor has already limited the “trainable skills options” as in the example of the putting coach, the trainable skills available for the practice have already been filtered. Custom trainable skill options may also be selected at this point. The instructor may also select whether he/she wants to increase the level of difficulty of the completion goals so as to push the student or to keep the goals steady (step 148). In this context, “push” means to set some or all of the completion goals to one score point higher than either the student's average score or the last score for the particular drill, which ever is higher. At this point, the initial result completion goal for drills in which the student has no prior history can be set to a preset default value (step 150).

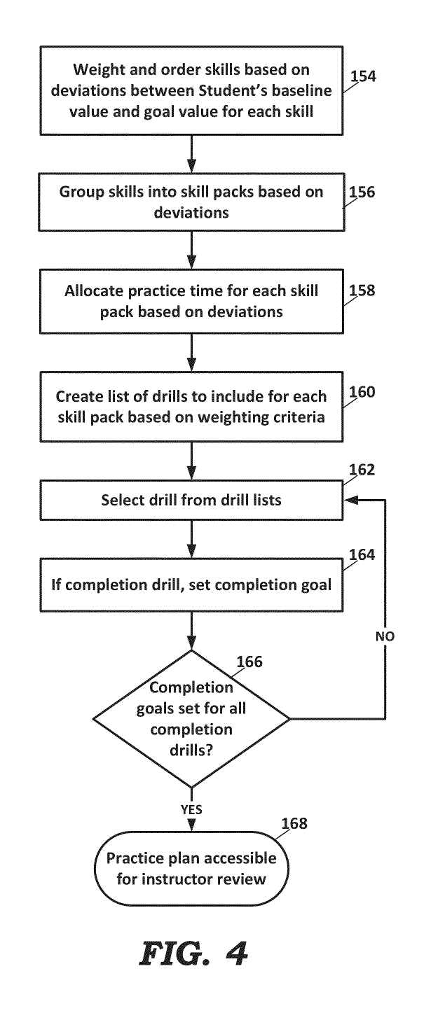

The application server 24 now generates a practice plan based on performance data and setup selections made by the instructor and/or student (step 128). Various steps in the practice plan generation process are depicted in FIG. 4. Based on the trainable skills available for this practice, the application server 24 weights and orders the skills based on the deviation between the student's baseline value and the student's goal value (step 154). In a preferred embodiment, these skills are then grouped into thirds based on the deviation, which are referred to herein as “skill packs” (step 156). The application server 24 allocates practice time for each skill pack based on the level of deviation for each skill pack (step 158). For example, the three skill packs may be allotted 50%, 25% and 25% of practice time respectively, going from highest deviation to lowest. Thus, the skill pack of trainable skills having the largest deviation gets 50% of the practice. Depending on how the practice plan is created, this could mean 50% of the estimated practice duration or 50% of the number of drills to be performed. In a preferred embodiment, these skill packs and the practice percentage allotments are system defaults that can be revised by capable instructors.

In some embodiments, there may be more trainable skills than skill pack groupings for a practice. Thus, in the above example, if there were four or more skills but only three skill pack groupings, the final skill pack could be a random selection from the remaining trainable skills. If the practice allowed for four or more skill pack groupings, 50% or less of the skill pack groupings could be filled via this random selection from the remaining skills. In another embodiment utilizing a four skill pack practice plan, 40% of the practice time may be devoted to the skill pack needing the most improvement, and 20% may be devoted to each of the other skill packs.

A student training for a complete golf game may be practicing ten to fifteen trainable skills. If the student is repeatedly training to improve the three or four weakest skills, practice sessions may become frustrating because the student is constantly working on the same skills that the student is bad at. This may cause the student to become frustrated and stop training. To avoid this situation, some embodiments include an option in the practice creation setup to allocate the last 50% of the practice session (one skill pack in a three skill pack scenario or two skill packs in a four skill pack scenario) to trainable skills that the student is better at or to a random selection of the remaining trainable skills, thereby increasing the student's confidence. In the preferred embodiment, the random selection would be from skills that all in the 30% having the lowest deviations.

In preferred embodiments, the skill packs, the number of skills trained per practice or ‘skill pack’ grouping, the allocation of the last skill pack or last 50%, and the practice percentage allotments are system defaults that can be revised by capable instructors or students.

With continued reference to FIG. 4, the application server 24 creates a list of drills to include for each skill pack based on weighting criteria (step 160). In a preferred embodiment, available drills are queried for each drill pack based on the trainable skills listed in the instructor's drill library in the database 26. In embodiments not involving an instructor, the available skills are queried from the student's drill library. Drills are then selected based on a weighted random selection within each drill pack query until the practice time allotment or number of drills quota is met. In a preferred embodiment, criteria for weighting is determined as follows, with all weighting preferably being equal and cumulative:
Instructor preference, if applicable, where certain drills are favorite (weighted higher) at certain levels. For example, an instructor may set a certain drill as always used when a certain trainable skill is included in the practice plan.
Student preference, if applicable.
Multiple skills in the drill pack trained by this drill.
Student's prior performance with a drill. For example, the student's history with using a particular drill may make that drill more or less likely to be selected again.

Drills may also be given a negative weighting if an instructor or student gives the drill a negative preference rating, meaning either they want to use that drill less or never again.

In a preferred embodiment, the application server 24 tracks the correlation between drill performance and the student's trainable skill improvement to determine the effectiveness of drills for trainable skills. For example, a student might be improving in the results of a scored drill for putting, but the drill does not improve the student's putting skills. After a set number of times completing this drill with no significant improvement, the effectiveness level for this drill in training putting could be downgraded. On the other hand, if progress in performing a drill over time correlates with improvement for that trainable skill, then that drill could be upgraded for effectiveness for that trainable skill. Because one drill can train multiple trainable skills, it is possible for a drill to be more effective at training certain trainable skills than the others.

The drill effectiveness may be determined by comparing the slope of the scored drill results of the last five practices to the trainable skill metrics from statistics entered for the last three competitions, assuming these sets of data are within an acceptable time frame. If the two slopes deviate by a value greater than an effectiveness threshold value defined in the system, then that drill is downgraded in effectiveness for that trainable skill. The less the slopes deviate over the defined data sets from drill practice and competition, the greater the effectiveness of that drill at training that skill.

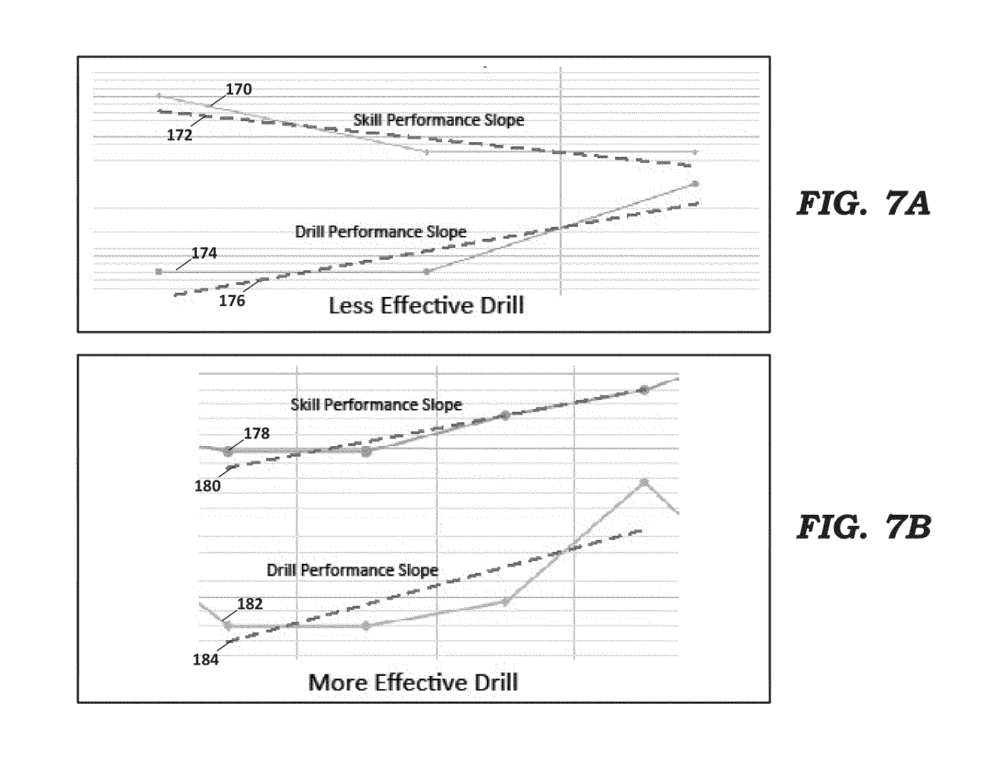

For example, FIG. 7A depicts a graph of results of measured performance of a skill during three competitions 170 and a computed straight line 172 fit to the three skill performance data points. The negative slope of the line 172 indicates a net decrease in success in performing the skill over the three competitions. FIG. 7A also depicts results from three practices 174 in which a drill is performed that is intended to increase the skill level and a computed straight line 176 fit to the three drill performance data points. The positive slope of the line 176 indicates a net increase in success in performing the drill during the three practices. The difference in the slopes of the lines 172 and 176 clearly indicates that the drill has not been effective in improving performance of the trainable skill.

FIG. 7B depicts an example wherein results of measured performance of a skill during four competitions 178 and the positive slope of the fit line 180 indicate improvement in performance over time. In this example, results from four practices 182 and the positive slope of the tit line 184 also indicate improvement in performance over time. The similarity in the slopes of the lines 180 and 184 indicates that the drill has been effective in improving performance of the trainable skill.

The drill effectiveness rating could be stored in the database 26 as a value ranging from one to five, for example. In a preferred embodiment, all drills start out at three and if they are downgraded they move down from a three, and if upgraded they move up from a three. The drill effectiveness rating may then be used in the weighting process for drill selection so that more effective drills are given greater weight. The drill effectiveness rating may also be tracked for different student skill levels. For instance, a drill might be more effective for a beginner and less effective for a professional and vice versa. These effectiveness ratings may also be utilized in the weighting process for a student only, for an instructor only, or globally across the system. For example, global drill effectiveness ratings may be utilized for the weighting of drills for any student or instructor that creates a practice plan. In some embodiments, if a drill is downgraded enough times for a specific trainable skill, by either sum of the downgrade values (deviation from a three value) or number of players it is downgraded for, it could be removed all together from that trainable skill's drill queries for practice creation. However, user or instructor preferences can override a drill's effectiveness weighting for a trainable skill in their weighting process.

When the weighting process is complete, the application server 24 selects drills from the weighted drill list, preferably at random (step 162). If a selected drill is a “scored drill,” then the application server 24 determines presets for the drill based on whether prior drill history is available for the particular student (step 164). If prior drill history is available and the practice settings include a “push” setting, then the completion goal is set to one score value higher than the 30-day average score or one score value higher than the last score for the drill, which ever is higher. If no prior history is available for a selected drill, the default goal is set for the drill, unless the instructor has selected a preset value for the practice.

In a preferred embodiment, all completion score drills are stored as percentages. In this way, if one drill has multiple different setups, the completion goal can be easily ascertained. For example, the drill may be “Hit the inside corner with your fastball” and the student is to throw 20 pitches. In previous practices involving this drill, the student threw eight, ten, and fifteen pitches. If the student's 30-day average is 75%, the completion goal is set to 75% of 20 pitches, which is 15 pitches. If the practice is a “push” practice, then the completion goal will be set to 16 pitches.

The drill selection and completion goal creation processes are repeated until all drill packs are filled to their allotments (step 166). Once this is done, the practice plan build is complete. If an instructor was involved, the practice plan is sent to the instructor for review (step 168). In some embodiments, the application server 24 may cause an email, text message, or other electronic notification to be sent to the instructor indicating that a practice plan is accessible and ready for review.

In the preferred embodiment depicted in FIG. 2 that involves the instructor, the instructor reviews and if necessary revises the drills and goals in the practice plan (step 130). During the review/revision process, the instructor may do any of the following:
Change a drill setup, such as number of attempts/repetitions or the completion goal.
Remove a drill from the practice plan and request the system select another drill to replace the removed drill. In this process, the application server 24 preferably uses the same drill selection process for the drill pack for which the removed drill was selected.
Remove a drill and select the replacement drill, and either request the system select the completion goal or the instructor sets the completion goal.
Remove a drill with no replacement.
Reorder the drills, if the instructor would like the drills to be completed in a certain order that is different from the order established by the system.

After the Instructor has approved the practice plan, the application server 24 publishes the practice plan or schedules it to be published for the student to access via the student computer 12 (step 132). A practice plan can either be scheduled for publication on a particular date, meaning it cannot be accessed by the student to enter results until that date, or the practice plan may be placed in a queue where the student may access it at any time and enter their results. With the queue option, the student may perform the practice multiple times and enter multiple sets of results. For example, the queue option may be selected when an instructor wants a student to complete the practice three times a week for two weeks. In some embodiments, the application server 24 may cause an email, text message, or other electronic notification to be sent to the student indicating that a practice plan has been published and is ready for viewing.

After a practice plan has published, a student may use the student computer 12 to tog in to the system, access the practice plan and view the list of drills in the practice plan (step 134). In embodiments wherein the student is linked in the database 26 to multiple instructors who have all created practice plans for the student, the application server 24 may be programmed with several options for how the student and instructors may access the practice plans:
The instructors can see all practice plans in the current queue for the student.
The instructors cannot see the practice plans in the current queue for the student.
The various practice plans scheduled by the instructors are all merged in the student's queue into one single practice plan.
The various practice plans scheduled by the instructors are all available as individual practice plans in the student's queue.

While viewing the published practice plan(s), the student uses the student computer 12 to select a practice plan and selects a drill in the selected plan (step 136). Typically, the student will select the first drill in the practice plan, but no particular selection order is required. In preferred embodiments, the application server 24 displays instructions for the student for how to complete the selected drill, what constitutes success for the drill, if applicable, and what the completion goal is, if applicable. If there is a completion goal, and the student has a performance history for the selected drill, that performance history information is also displayed for the student.

The student then performs the selected drill and enters the results into the student computer 12 (step 138). If the drill is a scored drill, the student enters the score. If the drill is a pass/fail drill, the students checks a box on the display of the student computer 12 indicating that the drill was completed. The student continues to select and perform the drills in the practice plan and enter results until all the drills are all complete.

As practice results are entered into the database 26, the application server 24 compiles the results (step 140) and makes the results available for review by the instructor(s) (step 142). Based on the student's practice results, the instructor may revise the practice plan for future practices (step 126), and steps 128 through 142 in FIG. 2 may be repeated to further hone the practice plan to achieve the best results for the student.

At some point after performing the practice drills, the student again participates in an organized game or competition in which the trainable skills are required (step 112), and the student enters data into the system indicating the student's performance in the latest game/competition (step 114). Based on this additional performance data, the application server 24 compiles updated statistical metrics for the trainable skills (step 124), which metrics are used in building further practice plans for the student (step 128). As more data points are entered based on multiple completions of practice drills and competitions, a solid data set for the student begins to develop.

In some embodiments, more variables/options may be added to practice creation to allow for more customization of practice plans, such as only training certain skills on certain days of the week. In some embodiments, the instructor has the ability to put added emphasis on certain skills, so that the weighted skill deficiencies are manipulated by values set by the instructor. In some embodiments, certain drills can be removed or used more frequently based on the student's or instructor's preferences, so the drills may have weighted values for use as well.

Embodiments of the invention described herein are applicable to practically any activity that involves the use of trainable skills. For example golf (driving, putting), baseball (hitting, pitching), playing a musical instrument, keyboarding and speed reading all require the use of trainable skills. FIGS. 5 and 6 list examples of trainable skills associated with golf and baseball, respectively, along with listings of instructors who may be involved in teaching those skills.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for generating a practice plan to use in training a student to improve in the performance of trainable skills associated with an activity, the method comprising:
(a) storing a plurality of trainable skills in a database that is accessible via a communication network;
(b) storing a plurality of drills in the database, each drill associated in the database with one or more of the trainable skills;
(c) selecting one or more of the trainable skills in which improved student performance is desired, the selecting performed using one or both of an instructor computer and a student computer connected to the communication network;
(d) assigning goal values for the trainable skills selected in step (c), the assigning performed using one or both of the instructor computer and the student computer;
(e) after the student participates in the activity during which the student performs one or more of the trainable skills, entering performance data in the database using the student computer, the performance data indicative of a level of skill exhibited by the student in performing the one or more trainable skills;
(f) determining baseline values for the one or more trainable skills selected in step (c) based on the performance data recorded in step (e), the determining performed by a computer processor in communication with the database;
(g) the computer processor generating the practice plan for the student by:
(g1) determining a deviation between the goal value and the baseline value for each trainable skill selected in step (c);
(g2) allocating a practice time for each trainable skill based at least in part on the deviations determined in step (g1), wherein trainable skills having the largest deviations are allocated more practice time than trainable skills having the smallest deviations;
(g3) selecting drills from the database that are associated with trainable skills having deviations greater than a minimum threshold value;
(g4) setting completion goals for the drills selected in step (g3) that are scored drills; and
(g5) compiling at least the drills, practice times, and completion goals as the practice plan; and
(h) making the practice plan accessible to one or both of the instructor computer and the student computer via the communication network.

2. The method of claim 1 wherein step (g2) further comprises:
based on the deviations determined in step (g1), grouping the trainable skills selected in step (c) into a plurality of skill packs, wherein one or more trainable skills having the largest deviations are grouped into a first skill pack, and one or more trainable skills having deviations smaller than those in the first skill pack are grouped into a second skill pack; and
allocating more practice time for the first skill pack than for the second skill pack.

3. The method of claim 2 wherein step (g2) further comprises:
based on the deviations determined in step (g1), grouping the trainable skills selected in step (c) into three skill packs, wherein one or more trainable skills having deviations smaller than those in the second skill pack are grouped into a third skill pack; and
allocating more practice time for the first skill pack than for the second skill pack or the third skill pack.

4. The method of claim 1 further comprising one or more of the following steps performed prior to step (g) using the instructor computer:
entering a parameter value that indicates a scope of the practice plan, the parameter value comprising one or more of an estimated time duration of the practice or a predetermined number of drills to be performed during the practice;
selecting particular drills from the database to include in the practice plan;
selecting whether to push the student in one or more of the selected drills; and
selecting completion goals for scored drills in which the student has no performance history.

5. The method of claim 1 further comprising:
step (h) comprising making the practice plan accessible to the instructor computer only;
(i) an instructor viewing the practice plan on the instructor computer;
(j) the instructor entering revisions to the practice plan using the instructor computer; and
(k) making the practice plan accessible to the student computer after step (j).

6. The method of claim 1 further comprising:
(i) the student viewing the practice plan on the student computer;
(j) the student selecting a drill from the practice plan to view using the student computer;
(k) the student completing the drill selected in step (j);
(l) the student entering results of the drill completed in step (k) into the database using the student computer;
(m) storing the results entered in step (l) in the database; and
(n) repeating steps (i) through (m) until all drills in the practice plan have been completed.

7. The method of claim 6 further comprising:
(o) accessing the practice plan and the results of the drills from the database using the instructor computer;
(p) an instructor viewing the practice plan and the results of the drills on the instructor computer;
(q) the instructor entering revisions to the practice plan based on the results of the drills using the instructor computer; and
(r) making a revised practice plan accessible to the student computer after step (q).

8. The method of claim 7 further comprising repeating steps (e) through (r) until one or more of the deviations determined in step (g1) are less than the minimum threshold value.

9. The method of claim 1 wherein the activity is selected from the group consisting of an athletic activity, a musical activity, an academic activity, and a workplace activity.

10. An apparatus for generating a practice plan to use in training a student to improve in the performance of trainable skills associated with an activity, the apparatus comprising:
a student computer connected to a communication network, the student computer operable to enter student account information, performance data, and results of drills, and to display the practice plan;
an instructor computer connected to the communication network, the instructor computer operable to enter instructor account information, selections of one or more of the trainable skills in which improved student performance is desired, and goal values for one or more selected trainable skills;
a database connected to the communication network, the database operable to store:
student account information in association with instructor account information;
one or more drills in association with the one or more selected trainable skills;
goal values in association with the one or more selected trainable skills and the student account information;
baseline performance values in association with the one or more selected trainable skills and the student account information;
performance data in association with the one or more selected trainable skills and the student account information, the performance data indicative of a level of skill exhibited by the student in performing the one or more selected trainable skills; and
practice plans in association with one or both of the student account information and the instructor account information; and
results of drills performed by the student in association with the student account information;
an application server computer in communication via the communication network with the student computer, the instructor computer and the database, the application server computer programmed with executable instructions to:
access the one or more selected trainable skills in which improved student performance is desired;
access the goal values for the one or more selected trainable skills;
access the performance data indicative of the level of skill exhibited by the student in performing the one or more selected trainable skills;
calculate the baseline performance values for the one or more selected trainable skills based on the performance data;
determine deviations between the goal values and the baseline performance values for the one or more selected trainable skills;
allocate practice times for the one or more selected trainable skills based at least in part on the deviations, wherein one or more selected trainable skills having the largest deviations are allocated more practice time than one or more selected trainable skills having the smallest deviations;
select drills from the database associated with the one or more selected trainable skills having deviations greater than a minimum threshold value;
set completion goals for selected drills that are scored drills;
compile at least the selected drills, the practice times, and the completion goals as the practice plan;
store the practice plan in the database in association with one or more of the student account information and the instructor account information; and
make the practice plan accessible to one or both of the instructor computer and the student computer via the communication network.

11. The apparatus of claim 10 wherein the application server computer is programmed with executable instructions to:
group the one or more selected trainable skills into a plurality of skill packs based on the deviations, wherein one or more selected trainable skills having the largest deviations are grouped into a first skill pack, and one or more selected trainable skills having deviations smaller than those in the first skill pack are grouped into a second skill pack; and
allocate more practice time for the first skill pack than for the second skill pack.

12. The apparatus of claim 11 wherein the application server computer is programmed with executable instructions to:
group the one or more selected trainable skills selected into three skill packs based on the deviations, wherein one or more selected trainable skills having deviations smaller than those in the second skill pack are grouped into a third skill pack; and
allocate more practice time for the first skill pack than for the second skill pack or the third skill pack.

13. The apparatus of claim 10 wherein the instructor computer is operable to perform one or more of the following functions:
entering a parameter value that indicates a scope of the practice plan, the parameter value comprising one or more of an estimated time duration of the practice or a predetermined number of drills to be performed during the practice;
selecting particular drills from the database to include in the practice plan;
selecting whether to push the student in one or more selected drills; and
selecting completion goals for scored drills in which the student has no performance history.

14. The apparatus of claim 10 wherein
the instructor computer is operable to access the practice plan and the results of drills from the database, and to enter revisions to the practice plan based on the results of the drills; and
the application server computer is programmed with executable instructions to compile a revised practice plan based at least in part on the revisions entered by the instructor computer.

15. The apparatus of claim 10 wherein the activity is selected from the group consisting of an athletic activity, a musical activity, an academic activity, and a workplace activity.

16. The apparatus of claim 10 further comprising:
a web server computer connected to the communication network, the web server computer programmed with executable instructions to transfer practice-related information to and from the student computer, the instructor computer, and the application server computer via the communication network, and to access and store practice-related information in the database;
the student computer executing a student web browser application for communicating with the web server computer; and
the instructor computer executing an instructor web browser application for communicating with the web server computer.

17. A method for generating a practice plan to use in training a student to improve in the performance of trainable skills associated with an activity, the method comprising:
(a) storing a plurality of trainable skills in a database that is accessible via a communication network;
(b) storing a plurality of drills in the database, each drill associated in the database with one or more of the trainable
(c) selecting a trainable skill in which improved student performance is desired, the selecting performed using one or both of an instructor computer and a student computer connected to the communication network;
(d) assigning goal values for the trainable skill selected in step (c), the assigning performed using one or both of the instructor computer and the student computer;
(e) after the student participates in the activity during which the student performs the trainable skill, entering a first set of performance data in the database using the student computer, the first set of performance data indicative of a level of skill exhibited by the student in performing the trainable skill;
(f) determining first baseline values for the trainable skill selected in step (c) based on the first set of performance data recorded in step (e), the determining performed by a computer processor in communication with the database;
(g) the computer processor generating the practice plan for the student based at least in part on the goal values and the first baseline values, the practice plan including one or more drills selected from the database;
(h) making the practice plan accessible to the student computer via the communication network;
(i) the student viewing the practice plan on the student computer;
(j) the student completing one or more of the drills in the practice plan during a practice;
(k) the student entering results of the one or more drills completed in step (j) into the database using the student computer;
(l) storing the results entered in step (k) in the database;
(m) after the student again participates in the activity during which the student performs the trainable skill, entering a second set of performance data in the database using the student computer, the second set of performance data indicative of a level of skill exhibited by the student in performing the trainable skill after completing step
(n) determining second baseline values for the trainable skill selected in step (c) based on the second set of performance data entered in step (m), the determining performed by the computer processor;
(o) the computer processor determining one or more effectiveness ratings for the one or more drills completed in step (j), the determining based on at least in part on the results of the drills stored in step (1) and differences between the first and second baseline values, wherein the differences between the first and second baseline values indicate whether the student has improved in performance of the trainable skill after completing the one or more drills;
(p) the computer processor generating a revised practice plan for the student based at least in part on the one or more effectiveness ratings for the one or more drills; and
(q) making the revised practice plan accessible to the student computer after step (p).

18. A method for generating a practice plan to use in training a student to improve in the performance of trainable skills associated with an activity, the method comprising:
(a) storing a plurality of trainable skills in a database that is accessible via a communication network;
(b) storing a plurality of drills in the database, each drill associated in the database with one or more of the trainable skills;
(c) selecting one or more of the trainable skills in which improved student performance is desired, the selecting performed using one or both of an instructor computer and a student computer connected to the communication network;
(d) assigning goal values for the trainable skills selected in step (c), the assigning performed using one or both of the instructor computer and the student computer;
(e) determining baseline values for the one or more trainable skills selected in step (c), the determining performed by a computer processor in communication with the database;
(f) the computer processor generating the practice plan for the student based at least in part on the goal values and the baseline values, the practice plan including one or more drills selected from the database;
(g) making the practice plan accessible to the student computer via the communication network;
(h) the student viewing the practice plan on the student computer;
(i) the student selecting a drill from the practice plan to view using the student computer;
(j) the student completing the drill selected in step (i);
(k) the student entering results of the drill completed in step (j) into the database using the student computer;
(l) storing the results entered in step (k) in the database;
(m) repeating steps (h) through (l) until all drills in the practice plan have been completed;
(n) the computer processor accessing the practice plan and the results of the drills from the database;
(o) the computer processor setting revised completion goals in a revised practice plan based on the results of the drills; and
(p) making the revised practice plan accessible to the student computer after step (o).
